(19) United States
(12) Patent Application Publication
(10) Pub. No.: US 2006/0008004 A1
(43) Pub. Date: Jan. 12, 2006

(54) Video encoder

(76) Inventors: Isao Karube, Yokohama (JP); Yoshinori Suzuki, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/172,889

(22) Filed: Jul. 5, 2005

(30) Foreign Application Priority Data
Jul. 6, 2004 (JP) 2004-198753

(51) Int. Cl. H04B 1/66; H04N 11/02; H04N 11/04; H04N 7/12

(52) U.S. Cl. 375/240.16; 375/240.12

(57) ABSTRACT

A is a video encoder includes a data storage for storing a prediction residual, the number of bits of the prediction residual, and a motion vector in each encoded picture, as well as a motion compensator for selecting a motion predict mode from an output of the data storage. The video encoder of the present is intended to solve the conventional problem in which the number of bits in estimation of the number of bits used to select a motion predict mode of the video encoder increases, since the conventional residual bits estimating function is not determined uniquely and the number of bits that depends on the congeniality of each input picture is not always obtained accurately.

### CLAIM OF PRIORITY

The present application claims priority from Japanese application JP 2004-198753, filed on Jul. 6, 2004, the content of which is hereby incorporated by reference into this application.

### FIELD OF THE INVENTION

The present invention relates to a digital video encoding technique.

### BACKGROUND OF THE INVENTION

There is a well-known method which is employed for high performance encoding processing of digital video pictures. This method makes good use of a relationship between time-adjacent frames to compensate for motions of those frames, thereby compressing information very efficiently. Actually, even in MPEG-1, -2, and -4, which are international standards of picture encoding, such a method is employed to encode information between frames/in each frame properly in conjunction with a discrete cosine transformation (DCT) to detect a motion vector of each Macroblock and to compensate for the object motion. A Macroblock as mentioned having means a unit of motion compensation that uses a luminance signal block consisting of 4 8×8-pixel blocks and 2 8×8-pixel color difference signal blocks corresponding to the luminance signal block spatially. In motion compensation processing, motion estimation and predict mode selection are very important factors. A motion vector as mentioned above means a vector for denoting a position in an area for making a comparison between reference pictures corresponding to Macroblocks of encoded pictures in motion compensation estimating.

In the case of motion estimation, a block matching method is usually employed. The method detects a motion vector for each Macroblock, and a similar block is searched for in the reference frame. And, as a standard for determining such a motion vector in the block matching method, a prediction residual obtained from both an input picture and a reference picture is usually used. To obtain an optimal motion vector, a conventional method for selecting a motion vector that minimizes the prediction residual has often been employed. However, there is also another method that takes into consideration the number of motion information bits in addition to the prediction residual described above. Prediction residual means the residual represented by a difference between an predicted picture and its original inputted picture.

Even in the method for selecting an optimal predict mode from a plurality of predict modes when in motion compensation, it is proposed that the number of bits in each mode, as well as the prediction residual should be used just like the motion vector determining method. In this regard, reference is made to Gary J. Sullivan and Thomas Wiegand: Rate-Distortion Optimization for Video Compression, IEEE Signal Processing Magazine, vol. 15, no. 6, pp. 74-90, Nov. 1998. In the standard video encoding methods, such as MPEG-1, -2, and -4, a plurality of predict modes are prepared so that a predict mode is selected for each Macroblock. A predict mode means a combination of a block size and a motion estimating method employed for the object motion estimation.

When selecting a motion vector and a motion predict mode, the prediction residual and the number of motion vector bits are generally taken into consideration. A method for applying different offsets to evaluation values is an example of a predict mode selecting method that gives consideration to the number of bits for picture encoding. This method cannot affect the number of motion information bits to each evaluation value accurately, however. This is why the technique disclosed in the official gazette of JP-A No. 16594/2001 employs a high-order function that is obtained by a test and approximated linearly as a residual bits estimating function used to measure the number of bits of prediction residual accurately.

### SUMMARY OF THE INVENTION

In the conventional encoder as described above, each residual bits estimating function is determined uniquely. On the other hand, the relationship between the prediction residual and the number of bits varies according to such characteristics as motion size and other factors of each picture, so that the prepared estimating functions are insufficient to estimate the number of bits accurately. Consequently, an improper mode comes to be selected sometimes even in a case in which a proper mode could be selected to reduce the number of bits. And, as a result, the number of bits often increases. That has been a problem. In addition, in case the number of bits is measured without using any estimating function, the processing throughput comes to increase significantly. That has been another problem.

In order to solve the above-stated problems, the present invention provides a picture encoder that is typically configured as follows. The picture encoder includes a data storage for storing a prediction residual in each encoded picture, the number of prediction residual bits, and a motion vector of the encoded picture, as well as a motion compensator for selecting a predict mode using an output of the data storage in a motion compensation processing. More specifically, the picture encoder can change a residual bits estimating function required to detect a motion to select a proper predict mode according to the characteristics of the object video picture.

Using the above-described encoder enables the residual bits estimating function used to determine a predict mode to be changed properly according to prediction residual information, motion vector information, and the number of bits of a residual signal of each encoded picture so as to estimate the number of information bits of the picture more accurately. Consequently, a motion vector and a predict type come to be selected appropriately to each object picture according to the characteristics of the picture, so that the picture quality in the picture encoder used to encode pictures in real time is improved.

### BRIEF DESCRIPTION OF THE DRAWINGS

FIG. 1 is a block diagram showing an example of a video encoder according to the present invention;

FIG. 2 is a block diagram of a motion compensator of the present invention;

FIG. 3 is a block diagram of a total bits estimator of the present invention;

FIG. 4 is a block diagram of a residual bits estimating function determining unit of the present invention; and

FIG. 5 is a vector diagram showing example of how to determine a residual bits estimating function according to the present invention.

### DETAILED DESCRIPTION OF THE PREFERRED EMBODIMENT

Hereunder, a preferred embodiment of the present invention will be described with reference to the accompanying drawings.

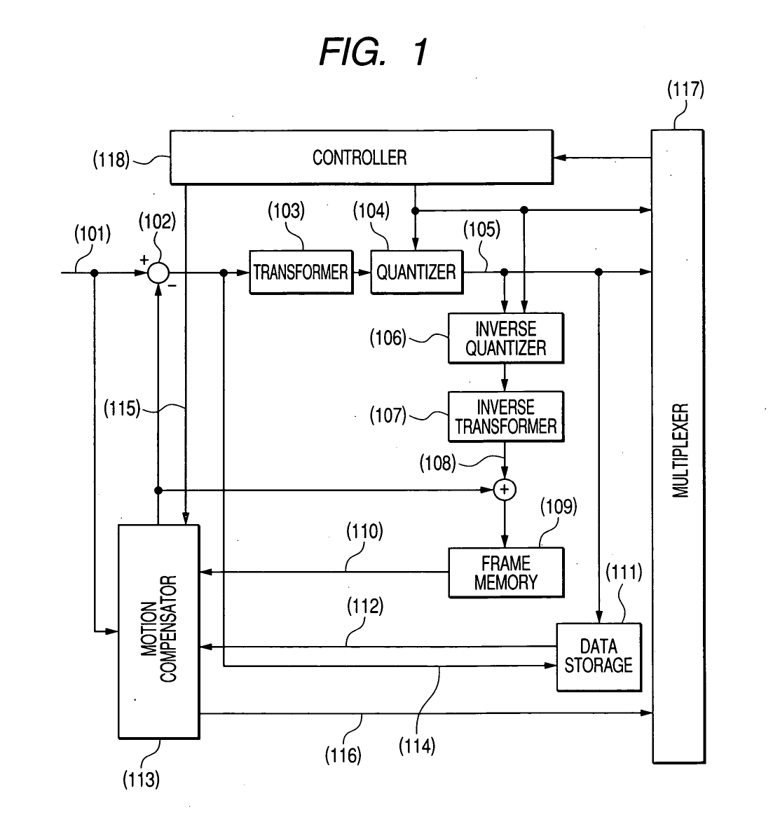

FIG. 1 is a block diagram of a picture encoder that is capable of changing the number of prediction residual bits appropriately according to the present invention. In FIG. 1, the reference numerals/symbols are defined as follows; 101 denotes an input picture signal, 103 denotes a transformer such as a DCT for transforming one frequency to another, 104 denotes a quantizer for compressing converted signals, 106 denotes an inverse quantizer, and 107 denotes an inverse converter. Quantizer parameter information is sent from a controller 118 to a motion compensator 113.

In case a picture 101 is inputted to an adder 102, a difference between the picture 101 and an output of the compensator 113 is calculated in the adder 102, and then the difference is output as an prediction residual signal. This prediction residual signal is converted in the transformer 103, then quantized in the quantizer 104 and output as a conversion coefficient. At that time, the number of bits of prediction residual are output together with the conversion coefficient as information 105. The information 105 is then output to a communication channel, as well as to the encoder, so that estimated pictures between frames are combined. The conversion coefficient 105 that is output into the encoder is quantized in an inverse quantizer 106, then subjected to inverse conversion in the inverse converter 107, and then an output picture from the motion compensator is added to the coefficient 105 to obtain a decoded picture of the current frame. This decoded picture is stored in a frame memory 109 and delayed just by one frame time therein. After that, the current picture 101 is inputted to the motion compensator 113 together with the preceding picture 110 that is stored in the frame memory 109 to determine a motion vector, and motion compensation is enabled again. This motion compensation method corresponds to the block matching method described above. Both the motion information and the motion predict mode generated in the motion compensator 113 are output as information 116 and are multiplexed together with such information as the prediction residual quantized in the quantizer 117 to be output to the object.

The number of quantized prediction residual bits 105 is stored in the storage 111. The data stored in the storage 111 is set corresponding to the prediction residual 114 generated in the adder 102, and then it is transferred to the motion compensator 113 as the number of bits 112 of the prediction residual of an encoded frame and is used to select a motion compensation method. In the picture encoder of the present invention, this motion compensator 113 changes the number of residual bits properly to encode the object information efficiently. Hereinafter, the method of operation will be described in detail.

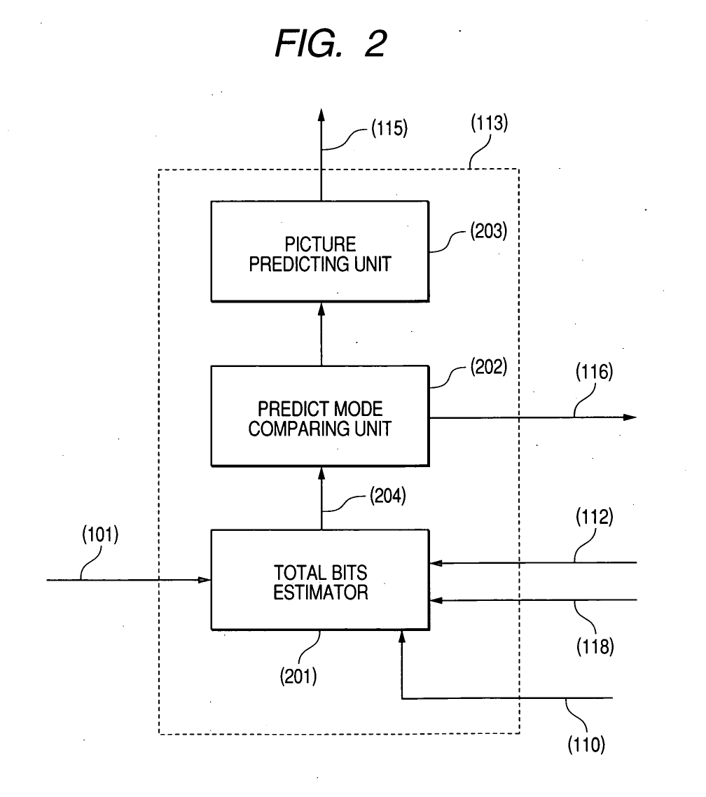

FIG. 2 shows the details of the motion compensator 113. In this case, a motion predict mode is selected from a plurality of predict modes and a predict picture is generated to minimize the data to be transmitted. At first, the total bits estimator 201 estimates the number of bits in each mode from the input picture 101, the reference picture 110, and the quantization parameter information 118. In this embodiment, the number of bits is represented by the sum of a motion vector and the number of prediction residual bits. The number of bits in each mode estimated in the total bits estimator 201 is output as the number of bits 204. The number of bits 204 is compared with another in the predict mode comparing unit 202 to select a mode that takes the minimum number of bits. Such a predict mode is configured by, for example, a pixel size such as 16×16, 8×8, or the like for an estimated block and methods for predicting both directions. The pixel size and the predicting methods are combined to specify a mode. And, according to the selected predict mode, a predict picture is generated by the picture predicting unit 203. The estimated picture is generated by copying pixels in an object range from the reference picture according to the motion vector.

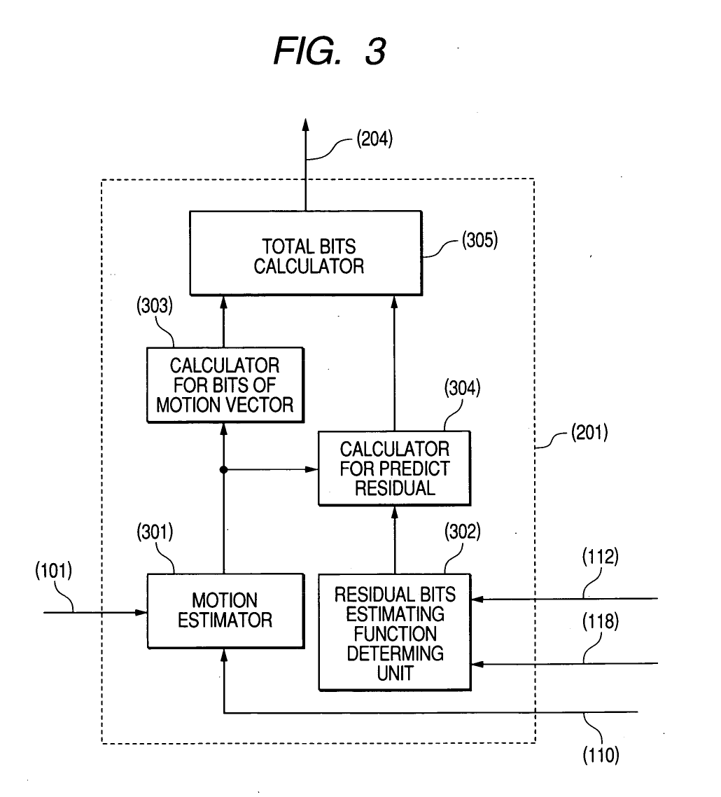

Next, the total bits estimator 201 will be described in detail with reference to FIG. 3. The residual bits estimating function determining unit 302 is provided beforehand with a plurality of residual bits estimating functions. A residual bits estimating function is determined by a relationship between a prediction residual and the number of bits in an encoded frame to be transmitted from a calculated data storage 111, as well as with the quantization parameter information 118. The residual bits estimating function will be described later. The motion vector estimator/residual calculator 301 calculates a motion vector in each mode from the picture 110 received from the frame memory and the input picture 101. Then, the calculator for bits of motion vector 303 calculates the number of bits of the motion vector in each mode according to the motion vector data received from the motion vector estimator/residual calculator 301. Then, the calculator for bits of prediction residual 304 calculates the number of bits of prediction residual in each mode with use of the function determined by the residual bits estimating function determining unit 302 and the motion vector data. The estimated value of the prediction residual bits calculated with the residual bits estimating function determined in the residual bits estimating function determining unit 302 is added to the motion vector bits calculated in the calculator for bits of motion vector 303 in the total bits calculator 305 to determine the total bits, which is then output to the motion predict mode comparing unit as the number of bits in each mode. As described above, because encoded data accumulated in the data storage is used to determine a residual bits estimating function appropriately to each encoded frame, the number of prediction residual bits is calculated accurately without requiring any frequency conversion in each mode.

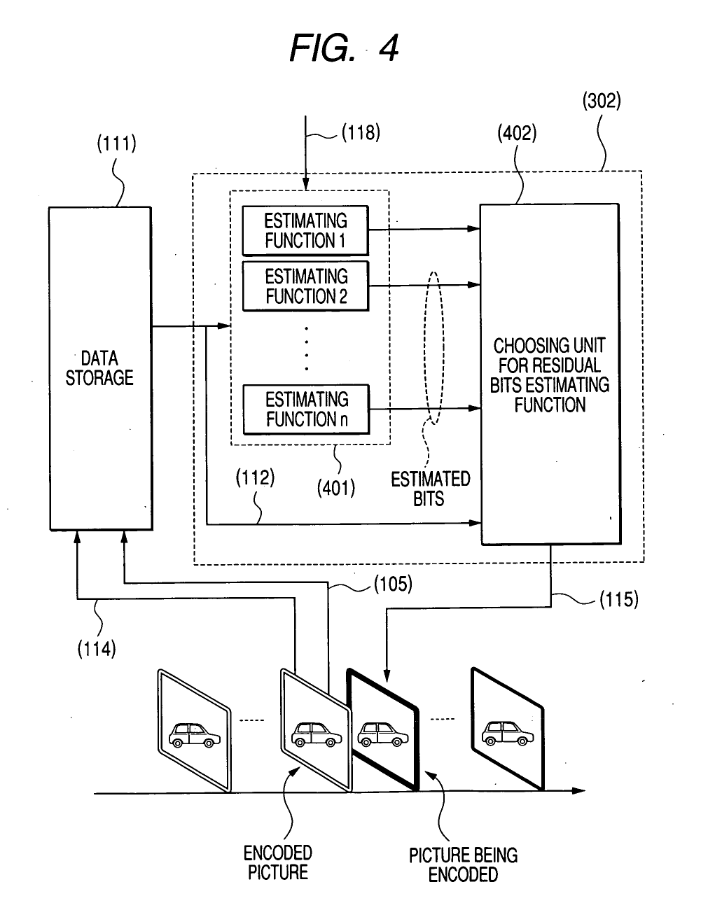

Next, a description will be given concerning the details of the residual bits estimating function determining unit 302 with reference to FIG. 4. Here, a simple example is shown for how to determine a residual bits estimating function according to the data of the preceding frame of a picture to be encoded. The prediction residual 105 and the prediction residual bits 114 in each encoded picture are stored in the data storage 111. The prediction residual 105 is output to the residual bits estimating function in each mode 401 and is used to calculate an estimated value of the prediction residual bits in IS each mode with use of the quantization parameter 118. After that, the estimated value of the residual bits in each mode is compared with the actual bits 112 in a choosing unit for residual bits estimating function 402 to select a function closest to the actual number of bits, and the function is applied to the picture being encoded.

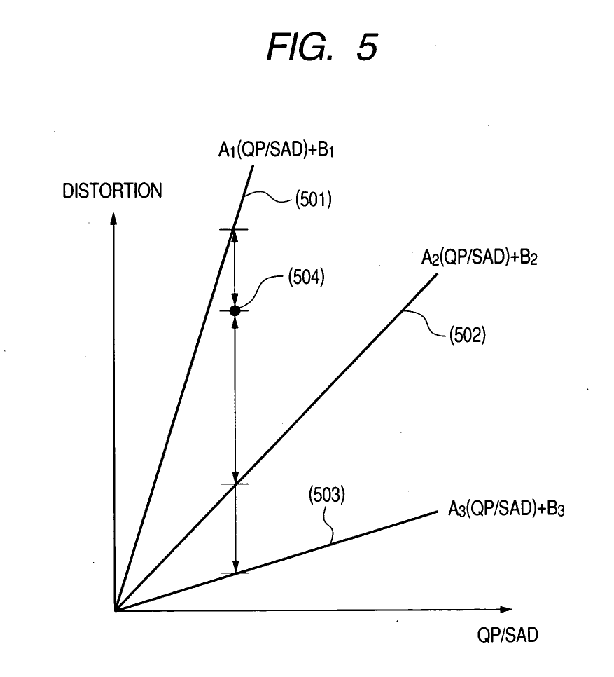

Next, a description will be given to indicate how the choosing unit for residual bits estimating function 402 selects a function with reference to FIG. 5. In this embodiment, the bits estimating function that represents the number of prediction residual bits is obtained by applying a linear approximation to a function found from encoded noise and the number of motion information bits. Here, A and B denote constants, QP denotes a quantization parameter, and SAD (Sum of Absolute Difference) denotes an absolute value of the residual bits.
A(QP/SAD)+B (Expression 1)

Each video picture is characterized in that, in case the picture has no motion, many regions that are not encoded are generated. Consequently, in this embodiment, three types A1, A2, A3 and B1, B2, B3 are prepared for each of the coefficients A and B in the expression 1 according to the picture motion size. The functions are shown as 501 to 503. Here, 501 to 503 correspond to residual bits estimating functions of a large motion picture, a general motion picture, and a small motion picture, respectively. In case data that assumes the relationship between the prediction residual and the number of bits to be 504 is inputted from the data storage, a function that minimizes the difference from each of the other functions is selected. In FIG. 5, the function 501 is the closest to the output from the data storage, thereby it is selected and used for a frame to be encoded.

In this embodiment, as a method for changing the motion information bits estimating function according to the characteristics of each picture, a plurality of linearly approximated residual bits estimating functions are prepared and a proper function is selected according to the quantization parameter, prediction residual, and the number of residual bits in each encoded frame. However, the present invention is not limited only to this method; the present invention can also apply to a case in which a plurality of parameters in a high-order function are changed.

What is claimed is:

1. A video encoder including:
a data storage for storing prediction residual, prediction residual bits, and a motion vector in an encoded picture, and
a motion compensator for selecting a predict mode in motion compensation using an output of said data storage.

2. The video encoder according to claim 1:
wherein said motion compensator includes a total bits estimator for estimating the total number of bits in an encoded picture using prediction residual and bits of prediction residual, and a predict mode comparing unit for selecting a predict mode using said estimated bits.

3. The video encoder according to claim 1:
wherein said residual bits estimating function used to select a predict mode of a current frame being encoded is changed according to a relationship between a preceding frame prediction residual and the number of bits in said bits estimator.

4. The video encoder according to claim 2:
wherein said residual bits estimating function used to select a predict mode of a current frame being encoded is changed according to a relationship between a preceding frame prediction residual and the number of bits in said bits estimator.

5. The video encoder according to claim 3:
wherein said residual bits estimating function is determined by selecting a function closest to said relationship between prediction residual and prediction residual bits of an encoded frame from a plurality of stored residual bits estimating functions in said bits estimator.

6. The video encoder according to claim 4:
wherein said residual bits estimating function is determined by selecting a function closest to said relationship between prediction residual and prediction residual bits of an encoded frame from a plurality of stored residual bits estimating functions in said bits estimator.
